(19) United States
(12) Patent Application Publication
(10) Pub. No.: US 2024/0250868 A1
(43) Pub. Date: Jul. 25, 2024

(54) ENDPOINT ENABLED NETWORKING DEVICES AND SYSTEMS

(71) Applicant: Mellanox Technologies, Ltd., Yokneam (IL)

(72) Inventors: Ortal Bashan, Tel Aviv (IL); Zachi Binshtock, Hod Hasharon (IL)

(21) Appl. No.: 18/100,632

(22) Filed: Jan. 24, 2023

(51) Int. Cl. H04L 41/0803; H04W 16/18

(52) U.S. Cl. CPC H04L 41/0803; H04W 16/18

(57) ABSTRACT

Apparatuses, systems, and associated methods for endpoint enabled networking devices are provided. An example endpoint enabled networking device includes one or more application-specific integrated circuits (ASICs) and a data processing unit (DPU) operably coupled with the one or more ASICs. The DPU is to generate control or data traffic associated with operation of the one or more ASICs. The endpoint-generated control or data traffic is generated local to the endpoint enabled networking device by the DPU on its own behalf. The endpoint-generated control or data traffic may be associated with example advanced telemetry operations and/or encryption operations.

### TECHNOLOGICAL FIELD

Embodiments of the present disclosure relate generally to networking and computing systems, and, more particularly, to endpoint enabled networking devices and systems in distributed networking and computing environments.

### BACKGROUND

Datacenters, high performance computing clusters, and/or the like are often implemented via distributed components (e.g., GPUs, servers, racks, switches, etc.). For example, a network fabric may be formed of a plurality of devices that are communicably coupled with a centralized management node and/or to one another. The centralized management node in such an implementation often transmits control data to these distributed network devices.

### BRIEF SUMMARY

Through applied effort, ingenuity, and innovation, many of the problems associated with conventional networking and computing systems have been solved by developing solutions that are included in embodiments of the present disclosure, many examples of which are described in detail herein. Embodiments of the present disclosure therefore provide for methods, systems, apparatuses, and computer program products for endpoint enabled networking devices. An example endpoint enabled networking device may include one or more application-specific integrated circuits (ASICs) and a data processing unit (DPU) operably coupled with the one or more ASICs. The DPU may generate control or data traffic associated with operation of the one or more ASICs. The endpoint-generated control or data traffic may be generated local to the endpoint enabled networking device by the DPU.

In some embodiments, the DPU may be communicably coupled with a centralized management node.

In some further embodiments, the DPU may receive one or more instructions for operating the one or more ASICs from the centralized management node.

In other further embodiments, the DPU may transmit the endpoint-generated control or data traffic generated locally by the DPU to the centralized management node.

In some embodiments, the endpoint-generated control or data traffic may be generated locally by the DPU on its own behalf.

In some embodiments, the endpoint-generated data traffic generated locally by the DPU may be associated with one or more advanced telemetry operations.

In some further embodiments, the DPU may transmit endpoint-generated data traffic associated with the one or more advanced telemetry operations to a centralized management node and/or to one or more telemetry collectors communicably coupled with the DPU.

In some embodiments, the endpoint-generated control or data traffic generated locally by the DPU may be associated with one or more encryption operations.

In some further embodiments, the DPU may generate an encrypted session between the endpoint enabled networking device and a centralized management node communicably coupled with the DPU.

In some embodiments, the DPU may generate an encrypted session between the endpoint enabled networking device and a second endpoint enabled networking device.

In any embodiments, the one or more ASICS may include a plurality of ASICs.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described certain example embodiments of the present disclosure in general terms, reference will now be made to the accompanying drawings. The components illustrated in the figures may or may not be present in certain embodiments described herein. Some embodiments may include fewer (or more) components than those shown in the figures.

FIG. 1 illustrates an example distributed network system or fabric in accordance with an example embodiment of the present disclosure;

FIG. 2 illustrates an example endpoint enabled networking device in accordance with an example embodiment of the present disclosure;

FIG. 3 illustrates a block diagram of example circuitry (e.g., DPU circuitry) that may be specifically configured in accordance with an example embodiment of the present disclosure; and

FIG. 4 illustrates a flowchart of an example method for generating control or data traffic by an endpoint enabled networking device in accordance with some embodiments of the present disclosure.

### DETAILED DESCRIPTION

### Overview

Various embodiments of the present disclosure will now be described more fully hereinafter with reference to the accompanying drawings in which some but not all embodiments are shown. Indeed, the present disclosure may be embodied in many different forms and should not be construed as limited to the embodiments set forth herein; rather these embodiments are provided so that this disclosure will satisfy applicable legal requirements. Like reference numerals refer to like elements throughout.

As described above, datacenters, high performance computing clusters, and/or the like are often implemented via distributed components (e.g., GPUs, servers, racks, switches, etc.). For example, a network may be formed of a plurality of devices that are communicably coupled with a centralized management node. In conventional software-defined networking solutions, the centralized management node transmits control data to these distributed network devices. In other words, the network devices in conventional software-defined networking solutions often fail to possess the capability to generate traffic (e.g., control or data) on their own behalf.

With the advent of emerging computing components, such as data processing units (DPUs), network devices may now be configured to perform additional operations that are traditionally associated with centralized management nodes or application nodes. In other words, conventional systems lacked the ability to generate control or data traffic locally, and the embodiments of the present disclosure provide endpoint enabled devices that generate this data locally by leveraging DPUs. For example, the endpoint enabled networking devices of the present disclosure may perform advanced telemetry operations, encryption options, and/or the like (e.g., locally generated control or data traffic) so as to enable these operations at the networking system level. By enabling network devices to perform these operations, the embodiments of the present disclosure may further increase the scalability of distributed networking capabilities that were traditionally limited by the operational capacity of a centralized management node.

As used herein, the terms “data,” “content,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein as receiving data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein as sending data to another computing device, it will be appreciated that the data may be sent directly to another computing device or may be sent indirectly via one or more intermediary computing devices, such as, for example, one or more servers, relays, routers, network access points, base stations, hosts, and/or the like.

Embodiments of the present disclosure are described below with reference to block diagrams and flowchart illustrations. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

The terms “illustrative,” “exemplary,” and “example” as may be used herein are not provided to convey any qualitative assessment, but instead merely to convey an illustration of an example. Thus, use of any such terms should not be taken to limit the spirit and scope of embodiments of the present disclosure. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily refer to the same embodiment).

### Endpoint Enabled Networking Devices and Systems

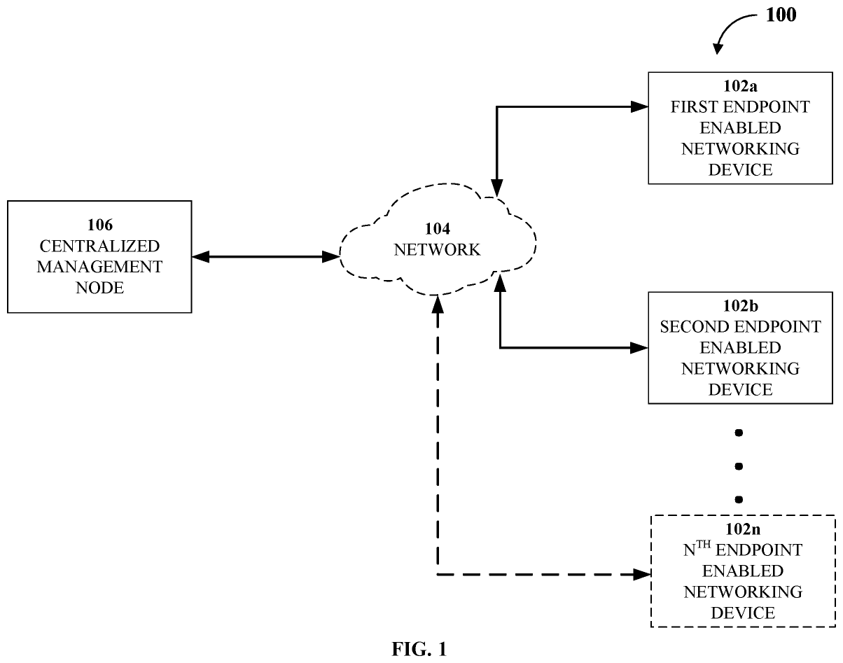

FIG. 1 illustrates an example networking system or fabric with endpoint enabled networking devices (e.g., networking system or fabric 100). It will be appreciated that the system 100 is provided as an example of an embodiment(s) and should not be construed to narrow the scope or spirit of the disclosure. The depicted networking system or fabric 100 of FIG. 1 may include a centralized management node 106 communicably coupled with one or more endpoint enabled networking devices 102a-n via a network 104. The centralized management node 106 may be configured to control or otherwise influence operations of the networking system or fabric 100 by, for example, operating as a host channel adapter (HCA) that generates control and/or data traffic. The centralized management node 106 may be configured to transmit traffic to (e.g., data, signals, etc.) and receive traffic from the one or more endpoint enabled networking devices 102a-n.

Although described hereinafter with reference to a centralized management node 106, the present disclosure contemplates that the operations described hereafter with reference to the centralized management node 106 (e.g., fabric or networking system level operations) may be performed by any computing device, system orchestrator, central processing unit (CPU), graphics processing unit (GPU), and/or the like. Furthermore, although illustrated as a single device (e.g., centralized management node 106), the present disclosure contemplates that any number of distributed components may collectively be used to form the centralized management node 106 and/or to perform the operations associated with the centralized management node 106. As described above and hereinafter, the centralized management node 106 may operate to manage the networking system or fabric 100. For example, the centralized management node 106 may operate to generate control traffic that is transmitted via the network 104 to one or more of the endpoint enabled networking devices 102a-n.

To facilitate or otherwise enable this connectivity, the communication network 104 may be any means including hardware, software, devices, or circuitry that is configured to support the transmission of traffic (e.g., data, signals, etc.) between nodes of the networking system or fabric 100. For example, the communication network 104 may be formed of components supporting wired transmission protocols, such as, digital subscriber line (DSL), InfiniBand®, Ethernet, fiber distributed data interface (FDDI), or any other wired transmission protocol obvious to a person of ordinary skill in the art. The communication network 104 may also be comprised of components supporting wireless transmission protocols, such as Bluetooth, IEEE 802.11 (Wi-Fi), or other wireless protocols obvious to a person of ordinary skill in the art. In addition, the communication network 104 may be formed of components supporting a standard communication bus, such as, a Peripheral Component Interconnect (PCI), PCI Express (PCIe or PCI-e), PCI extended (PCI-X), Accelerated Graphics Port (AGP), or other similar high-speed communication connection. Further, the communication network 104 may be comprised of any combination of the above mentioned protocols. In some embodiments, such as when one or more of the endpoint enabled networking devices 102a-n and the centralized management node 106 are formed as part of the same physical device, the communication network 104 may include the on-board wiring providing the physical connection between the component devices.

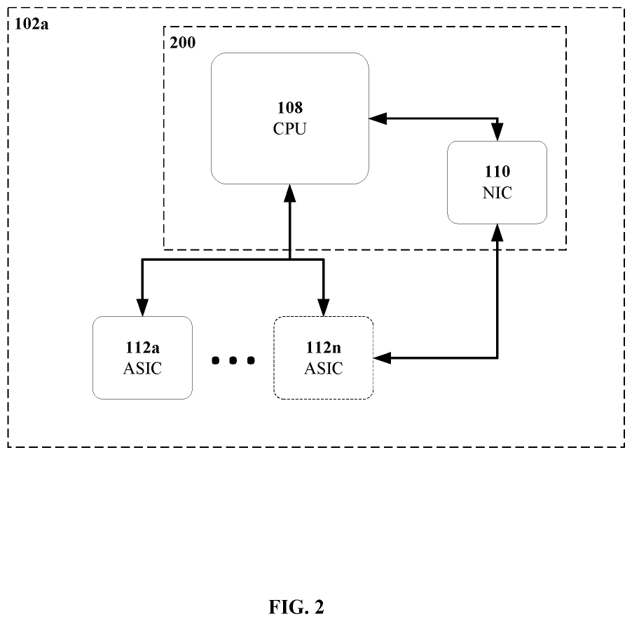

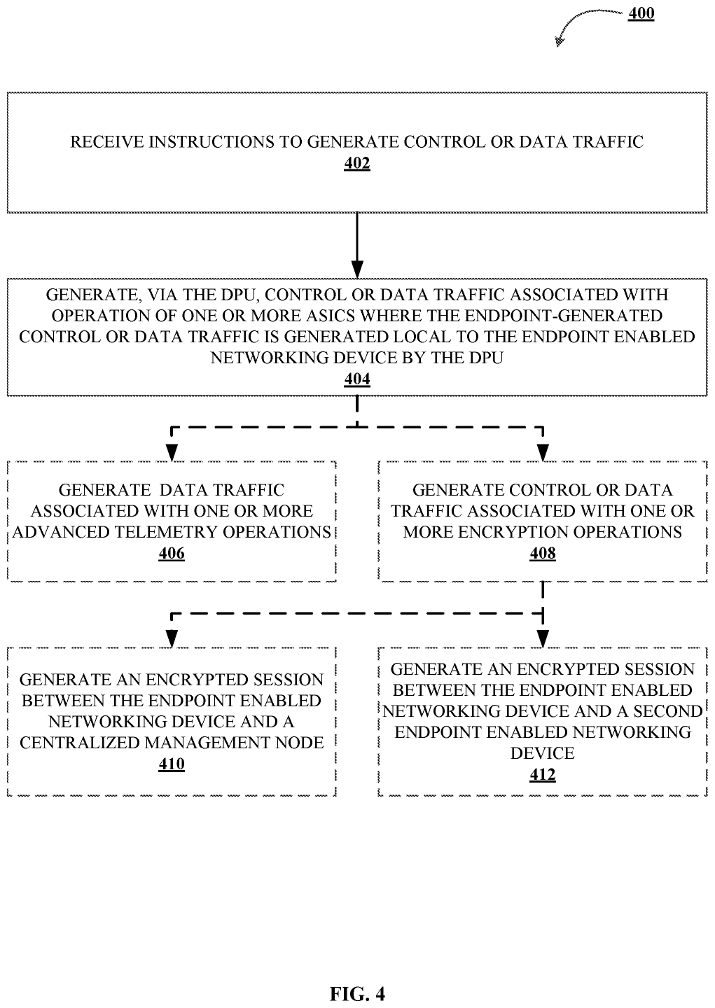

As described above, in traditional software-defined networking solutions, the centralized management node 106 transmits control data to these distributed network devices. In other words, the network devices in conventional software-defined networking solutions often fail to possess the capability to generate traffic (e.g., control or data) on their own behalf. For example, networking devices in a conventional system that are communicably coupled with a centralized management node (e.g., such as centralized management node 106) may only fetch or receive control traffic from the centralized management node 106. In contrast to the host channel adapter (HCA) functionality of the centralized management node 106, these conventional networking devices only offer target channel adapter (TCA) functionality As described hereafter with reference to FIGS. 2 and 4, the networking system or fabric 100 of the present disclosure may leverage emerging component components (e.g., DPUs) to provide endpoint enabled networking devices 102a-n that not only receive control or data traffic (e.g., provide TCA functionality) but also generate control or data traffic (e.g., provide HCA functionality). In doing so, the endpoint enabled networking devices 102a-n of the present disclosure are capable of performing operations (e.g., generating control or data traffic) so as to enable operations at the networking system level which were historically unavailable, such as performing advanced telemetry operations, encryption options, and/or the like. By enabling network devices to perform these operations, the embodiments of the present disclosure may further increase the scalability of distributed networking capabilities that were traditionally limited by the operational capacity of the centralized management node 106.

With reference to FIG. 2, an example first endpoint enabled networking device 102a is illustrated. Although described hereinafter with reference to components of the first endpoint enabled networking device 102a, the present disclosure contemplates that each of the endpoint enabled networking devices 102a-n may include substantially the same components as the first endpoint enabled networking device 102a. For example, the present disclosure contemplates that each of the endpoint enabled networking devices 102a-n may include a DPU 200 as described hereafter for generating control and data traffic local to the respective device 102a-n. Furthermore, although illustrated and described herein with reference to an example first endpoint enabled networking device 102a and a second endpoint enabled networking device 102b, the present disclosure contemplates that the networking system or fabric 100 may include any number of endpoint enabled networking devices 102a-n based upon the intended application of the fabric 100.

As shown in FIG. 2, the first endpoint enabled networking device 102a may include one or more application-specific integrated circuits (ASICs) 112a-n (e.g., first ASICs) that are communicably coupled with a data processing unit (DPU) 200 (e.g., first DPU). The one or more ASICs 112a-n may be configured for performing one or more networking operations and may be specific to the particular functionality associated with the first endpoint enabled networking device 102a. By way of non-limiting example, the one or more ASICs 112a-112n may be configured to operate as network ports in which traffic (e.g., data, signals, etc.) are directed to various components, devices, etc. communicably coupled with the ASICs 112a-n. The present disclosure contemplates that the first endpoint enabled networking device 102a may include any number of ASICs 112a-n (e.g., a plurality of ASICs 112a-n) based upon the intended application of the first endpoint enabled networking device 102a. Additionally, the present disclosure contemplates that the operations performed by the one or more ASICs 112a-n may similarly vary based upon the intended application of the first endpoint enabled networking device 102a. Still further, the present disclosure contemplates that the number, configuration, orientation, operations, etc. of the ASICs 112a-n may vary between endpoint enabled networking devices 102a-102n.

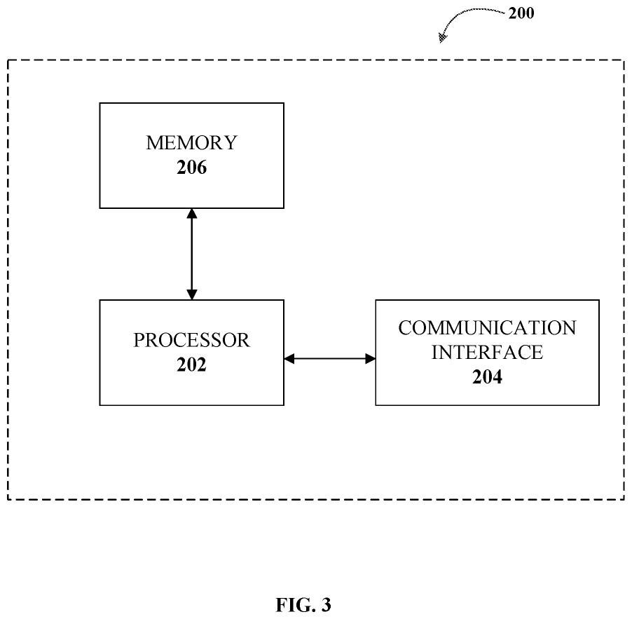

The first endpoint enabled networking device 102a may further include a DPU 200 that is operably coupled with the one or more ASICs 112a-112n. As shown, the DPU 200 may include a high-performance, software-programmable central processing unit (CPU) 108 that is communicably coupled with a network interface controller (NIC) 110. As described hereinafter with reference to the circuitry components of FIG. 3 and the operations of FIG. 4, the CPU 108 and the NIC 110 may be configured to generate control or data traffic associated with operation of the one or more ASICs 112a-n. Unlike conventional implementations in which this control or data traffic is generated by the centralized management node 106 and provided to the networking devices, the DPU 200 of the present disclosure enables the endpoint enabled networking devices 102a-n to generate control or data traffic locally by the DPU 200 on its own behalf. In other words, the endpoint-generated control or data traffic is generated local to the first endpoint enabled networking device 102a by the DPU 200.

As described hereinafter with reference to FIG. 4, the endpoint enabled networking devices 102a-n may continue to provide TCA related operations in conjunction with the HCA operations enabled by the DPU 200. For example, the DPU 200 may be communicably coupled with the centralized management node 106 and configured to fetch control or data traffic therefrom. In such an example embodiment, the DPU 200 may be configured to receive one or more instructions for operating the one or more ASICs 112a-n from the centralized management node 106. For example, the DPU 200 may fetch or otherwise receive instructions for generating control or data traffic by the DPU 200 local to the first endpoint enabled networking device 102a. Said differently, in some embodiments, the centralized management node 106 may continue to control operation of the networking system or fabric 100; however, the first endpoint enabled networking device 102a may generate control or data traffic locally by the DPU 200 on its own behalf.

Each endpoint enabled networking device 102a-n may be embodied in an entirely hardware embodiment, an entirely computer program product embodiment, an entirely firmware embodiment (e.g., application-specific integrated circuit, field-programmable gate array, etc.), and/or an embodiment that comprises a combination of computer program products, hardware, and firmware. In some embodiments, one or more of the endpoint enabled networking devices 102a-n may be embodied on the same physical device as the centralized management node 106. In some embodiments, one or more of the endpoint enabled networking devices 102a-n may be remote to the system 100. Still, in some embodiments, one or more endpoint enabled networking device 102a-n may be located on the same physical device as the centralized management node 106 and one or more endpoint enabled networking devices 102a-n may be remote to the centralized management node 106 and connected through a communication network 104.

### Example DPU Circuitry

With reference to FIG. 3, example circuitry components of the DPU 200 (e.g., the CPU 108 and/or the NIC 110) are illustrated that may, alone or in combination with any of the components described herein, be configured to perform the operations described herein with reference to FIG. 4. As shown, the DPU 200 may include, be associated with or be in communication with processor 202, a memory 206, and a communication interface 204. The processor 202 may be in communication with the memory 206 via a bus for passing information among components of the DPU 200. The memory 206 may be non-transitory and may include, for example, one or more volatile and/or non-volatile memories. In other words, for example, the memory 206 may be an electronic storage device (e.g., a computer readable storage medium) comprising gates configured to store data (e.g., bits) that may be retrievable by a machine (e.g., a computing device like the processing circuitry). The memory 206 may be configured to store information, data, content, applications, instructions, or the like for enabling the apparatus to carry out various functions in accordance with an example embodiment of the present disclosure. For example, the memory 206 could be configured to buffer input data for processing by the processor 202. Additionally or alternatively, the memory 206 could be configured to store instructions for execution by the processor 202.

The DPU 200 may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present disclosure on a single chip or as a single “system on a chip.” As such, in some cases, a chip or chipset may constitute means for performing one or more operations for providing the functionalities described herein.

The processor 202 may be embodied in a number of different ways. For example, the processor 202 may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining and/or multithreading.

In an example embodiment, the processor 202 may be configured to execute instructions stored in the memory 206 or otherwise accessible to the processor 202. Alternatively or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processor 202 is embodied as an executor of instructions, the instructions may specifically configure the processor to perform the algorithms and/or operations described herein when the instructions are executed. However, in some cases, the processor 202 may be a processor of a specific device configured to employ an embodiment of the present disclosure by further configuration of the processing circuitry by instructions for performing the algorithms and/or operations described herein. The processor 202 may include, among other things, a clock, an arithmetic logic unit (ALU) and logic gates configured to support operation of the processing circuitry.

The communication interface 204 may be any means such as a device or circuitry embodied in either hardware or a combination of hardware and software that is configured to receive and/or transmit data, including media content in the form of video or image files, one or more audio tracks or the like. In this regard, the communication interface 204 may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms. By way of a non-limiting example, the communication interface 204 may include a host interface (e.g., PCIe or the like) and a network interface (e.g., Ethernet, InfiniBand®, or the like).

Of course, while the term “circuitry” should be understood broadly to include hardware, in some embodiments, the term “circuitry” may also include software for configuring the hardware. For example, although “circuitry” may include processing circuitry, storage media, network interfaces, input/output devices, and the like, other elements of the DPU 200 may provide or supplement the functionality of particular circuitry.

### Example Methods Generating Control or Data Traffic

FIG. 4 illustrates a flowchart containing a series of operations for generating, locally via the DPU 200, control or data traffic. The operations illustrated in FIG. 4 may, for example, be performed by, with the assistance of, and/or under the control of an apparatus (e.g., DPU 200), as described above. In this regard, performance of the operations may invoke one or more of processor 202, memory 206, and/or communication interface 204.

As shown in operation 402, the apparatus (e.g., DPU 200) includes means, such as processor 202, or the like, for receiving instructions to generate control or data traffic. As described above, in some embodiments, the DPU 200 may be communicably coupled with the centralized management node 106 and configured to receive data therefrom. As such, although the control or data traffic may be generated locally by the DPU 200, the centralized management node 106 may, at least in part, cause the DPU 200 to generate this control or data traffic. In other embodiments, the receipt of instructions at operation 402 may refer to an internal determination by the endpoint enabled networking device 102 to generate control or data traffic. By way of example, the DPU 200 may receive and/or monitor data from the one or more ASICs 112a-n communicably coupled thereto. In response to this data, the DPU 200 may generate control or data traffic (e.g., for advanced telemetry or the like) so as to perform various operations local to the first endpoint enabled networking device 102 that were traditionally unavailable.

Thereafter, as shown in operation 404, the apparatus (e.g., DPU 200) includes means, such as processor 202, or the like, for generating, via the DPU 200, control or data traffic associated with operation of one or more ASICs 112a-n. As described herein, this endpoint-generated control or data traffic is generated local to the endpoint enabled networking device 102a-n by the DPU 200. As described hereafter with reference to operation 406, in some embodiments, the endpoint-generated control or data traffic may be associated with one or more advanced telemetry operations. By way of a particular example, the DPU 200 may generate data traffic (e.g., locally by the DPU 200) associated with one or more Reliable Connectivity (RC) telemetry sessions and session based Remote Direct Memory Access (RDMA)/RDMA over Converged Ethernet (RoCE) as described hereafter. As described hereafter with reference to operations 408-412, in some embodiments, the endpoint-generated control or data traffic may be associated with one or more encryption operations. Although described hereinafter with reference to advanced telemetry and encryption as non-limiting examples, the present disclosure contemplates that control or data traffic associated with any advanced telemetry operations and/or any other HCA related operations traditionally associated with centralized management nodes 106 may be generated by the DPU 200.

In some embodiments, as shown in operation 406, the apparatus (e.g., DPU 200) includes means, such as processor 202, or the like, for generating data traffic associated with one or more advanced telemetry operations. As would be evident to one of ordinary skill in the art, telemetry refers to network measurement operations, particularly at a data packet level, used for gaining networking insight(s) and facilitating network or fabric management. In conventional networking systems or fabrics, the centralized management node 106 causes generation of advanced telemetry related data traffic that is pushed to or fetched by distributed networking devices. In these conventional systems, hardware limitations at the networking device level prevent the generation of advanced session based data traffic by the networking device on its own behalf resulting in scalability limitations for the networking system or fabric as a whole.

In the first endpoint enabled networking device 102a, for example, the DPU 200 may be configured to generate data traffic (e.g., endpoint-generated data traffic) that is associated with one or more advanced telemetry operations. By way of a non-limiting example, the endpoint-generated data traffic may be associated with one or more RC telemetry sessions and session based RDMA/ROCE. In such an example, the endpoint-generated data traffic generated by the DPU 200 may be associated with generating one or more RC telemetry sessions and session based RDMA/ROCE wherein the first endpoint enabled networking device 102a and the centralized management node 106 and/or the second endpoint enabled networking device 102b may exchange data in main memory without relying on receptive processors, caches, or operating systems of either component. In some embodiments, the first endpoint enabled networking device 102a may transmit the endpoint-generated control or data traffic generated locally by the DPU 200 to the centralized management node 106 and/or a telemetry collector or sink. By way of example, the system 100 may, in some embodiments, include a database, repository, device, and/or the like (e.g., a telemetry collector or sink) configured to receive and/or store the endpoint-generated control or data traffic generated locally by the DPU 200. Although described herein with reference to port mirroring, the present disclosure contemplates that data traffic associated with any advanced telemetry operations may be generated locally by the DPU 200 on its own behalf based upon the intended application of the first endpoint enabled networking device 102a.

In some embodiments, as shown in operation 408, the apparatus (e.g., DPU 200) includes means, such as processor 202, or the like, for generating control or data traffic associated with one or more encryption operations. By way of an additional example, conventional networking system or fabrics rely upon a centralized management node 106 in order to generate control or data traffic associated with encrypting channels, generating encrypted sessions, etc. between networking devices within the system or fabric 100. In the embodiments of the present disclosure; however, the first endpoint enabled networking device 102a may, via the DPU 200, generate control or data (e.g., endpoint generated control or data traffic) associated with one or more encryption operations.

In some embodiments, as shown in operation 410, the apparatus (e.g., DPU 200) includes means, such as processor 202, or the like, for generating an encrypted session between the first endpoint enabled networking device 102a and the centralized management node 106 communicably coupled with the DPU 200. By way of example, the DPU 200 of the first endpoint enabled networking device 102a may generate control or data traffic for establishing an encrypted or otherwise secure session and provide this endpoint-generated control or data traffic to the centralized management node 106 to establish an encrypted session therebetween. In some embodiments, as shown in operation 412, the apparatus (e.g., DPU 200) includes means, such as processor 202, or the like, for generating an encrypted session between the first endpoint enabled networking device 102a and a second endpoint enabled networking device 102b. As illustrated in FIG. 1, the networking system or fabric 100 may include any number of distributed endpoint enabled networking devices 102a-n that may include the same or substantially the same functionality and components as the first endpoint enabled networking device 102a of FIG. 2. In such an embodiment, the first DPU 200 of the first endpoint enabled networking device 102a may generate control or data traffic for establishing an encrypted or otherwise secure session and provide this endpoint-generated control or data traffic to the second endpoint enabled networking device 102b to establish an encrypted session therebetween.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components may be used in conjunction with the system. Therefore, it is to be understood that the inventions are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. The disclosed embodiments relate primarily to a network interface environment, however, one skilled in the art may recognize that such principles may be applied to any scheduler receiving commands and/or transactions and having access to two or more processing cores. Alternative embodiments that result from combining, integrating, and/or omitting features of the embodiment(s) are also within the scope of the disclosure. Accordingly, the scope of protection is not limited by the description set out above.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

1. An endpoint enabled networking device comprising:
one or more application-specific integrated circuits (ASICs); and
a data processing unit (DPU) operably coupled with the one or more ASICs, wherein the DPU comprises a central processing unit (CPU) and a network interface card (NIC) operably coupled to the CPU,
wherein the DPU is operative to generate control or data traffic associated with operation of the one or more ASICs, and
wherein the control or data traffic is generated local to the endpoint enabled networking device by the DPU.

2. The endpoint enabled networking device according to claim 1, wherein the DPU is communicably coupled with a centralized management node.

3. The endpoint enabled networking device according to claim 2, wherein the DPU is operative to receive one or more instructions for operating the one or more ASICs from the centralized management node.

4. The endpoint enabled networking device according to claim 2, wherein the DPU is operative to transmit the control or data traffic generated locally by the DPU to the centralized management node.

5. The endpoint enabled networking device according to claim 2, wherein the control or data traffic is generated locally by the DPU on its own behalf.

6. The endpoint enabled networking device according to claim 1, wherein the data traffic generated locally by the DPU is associated with one or more advanced telemetry operations.

7. The endpoint enabled networking device according to claim 6, wherein the DPU is operative to transmit data traffic associated with the one or more advanced telemetry operations to a centralized management node communicably coupled with the DPU.

8. The endpoint enabled networking device according to claim 1, wherein the control or data traffic generated locally by the DPU is associated with one or more encryption operations.

9. The endpoint enabled networking device according to claim 8, wherein the DPU is operative to generate an encrypted session between the endpoint enabled networking device and a centralized management node communicably coupled with the DPU.

10. The endpoint enabled networking device according to claim 8, wherein the DPU is operative to generate an encrypted session between the endpoint enabled networking device and a second endpoint enabled networking device.

11. (canceled)

12. A system comprising:
a centralized management node; and
a first endpoint enabled networking device operably coupled to the centralized management node, wherein the first endpoint enabled networking device comprises:
one or more first application-specific integrated circuits (ASICs); and
a first data processing unit (DPU) operably coupled with the one or more first ASICs, wherein the first DPU comprises a central processing unit (CPU) and a network interface card (NIC) operably coupled to the CPU,
wherein the first endpoint enabled network device is operative to generate, using the first DPU, first control or data traffic associated with operation of the one or more first ASICs, and
wherein the first control or data traffic is generated local to the first endpoint enabled networking device.

13. The system according to claim 12, wherein the first DPU is operative to receive one or more instructions for operating the one or more first ASICs from the centralized management node.

14. The system according to claim 12, wherein the first DPU is operative to transmit the first control or data traffic generated locally by the DPU to the centralized management node.

15. The system according to claim 12, wherein the first control or data traffic is generated locally by the first DPU on its own behalf.

16. The system according to claim 12, wherein the first control or data traffic generated locally by the first DPU is associated with one or more advanced telemetry operations or one or more encryption operations.

17. The system according to claim 12, further comprising:
a second endpoint enabled networking device communicably coupled with the centralized management node, the second endpoint enabled networking device comprising:
one or more second ASICs; and
a second data processing unit (DPU) operably coupled with the one or more second ASICs, wherein the second DPU comprises a second central processing unit (CPU) and a second network interface card (NIC) operably coupled to the CPU,
wherein the second endpoint enabled networking device is operative to generate, using the second DPU, second control or data traffic associated with operation of the one or more second ASICs, and
wherein the second control or data traffic is generated local to the second endpoint enabled networking device.

18. The system according to claim 17, wherein the second control or data traffic is generated locally by the second DPU on its own behalf.

19. The system according to claim 7, wherein the first endpoint enabled networking device is further communicably coupled with the second endpoint enabled networking device.

20. The system according to claim 19, wherein a secure session between the first endpoint enabled networking device and the second endpoint enabled networking device is established via the first control or data traffic and the second control or data traffic.
